(19) United States
(12) Patent Application Publication
(10) Pub. No.: US 2016/0252192 A1
(43) Pub. Date: Sep. 1, 2016

(54) ARTICULATION JOINT LINKAGE

(71) Applicant: CATERPILLAR INC., Peoria, IL (US)

(72) Inventor: Paul Anthony SHEEHAN, Leicestershire (GB)

(73) Assignee: Caterpillar Inc., Peoria, IL (US)

(21) Appl. No.: 15/030,415

(22) PCT Filed: Oct. 28, 2014
(86) PCT No.: PCT/US2014/062640

§ 371 Date: Apr. 19, 2016

(30) Foreign Application Priority Data
Nov. 5, 2013 (GB) 1319505.2

(51) Int. Cl. F16K 31/60; E02F 9/00; E02F 9/08; F16C 11/06

(52) U.S. Cl. CPC F16K 31/602; F16C 11/06; E02F 9/006; E02F 9/0841

(57) ABSTRACT

The present disclosure provides an articulation joint linkage. The articulation joint linkage includes a first socket having a ball seat at a distal end. The articulation joint linkage includes a ball stud having a ball and a shank extending from the ball, the ball is arranged in the ball seat such that the ball stud is configured to articulate with respect to the first socket. The articulation joint linkage includes a locking ferrule. The locking ferrule includes a cavity receiving the ball therein, wherein the locking ferrule is attached to the first socket to hold the ball within the ball seat. The locking ferrule includes an opening, wherein the shank extends through the opening. The articulation joint linkage further includes a second socket having a bore receiving the shank of the ball stud therein.

### TECHNICAL FIELD

Present disclosure relates to an articulation joint linkage and more particularly to the articulation joint linkage for a linkage assembly.

### BACKGROUND

Conventionally machines which perform digging or loading functions such as excavators, backhoe loaders, and front shovels, have an implement assembly controlled by two or more hand operated levers. Typically, the hand operated levers are coupled to a linkage assembly. A movement in the hand operated levers is transmitted to a hydraulic valve assembly via the linkage assembly to actuate one or more hydraulic cylinders associated with the operation of the implement assembly. Generally, the hydraulic valve assembly is coupled to the linkage assembly via a linkage joint. The linkage joint offers a clearance between the linkage assembly and the hydraulic valve assembly. This clearance creates a free-play between the linkage assembly and the hydraulic valve assembly and may lead to a slack in transfer of motion from the hand operated levers to the hydraulic valve assembly.

U.S. Pat. No. 4,938,091 discloses a three-function control lever is provided with a main ball joint operatively coupling the control lever to a console. An operator plate is coupled to the control lever for manipulating a first and second control link for manipulating a first and second hydraulic control valve. The first and second control links are coupled to the operator plate by first and second auxiliary ball joints. A radially extending arm projecting from the control lever controls the positioning of a third link for manipulating a third hydraulic control valve. The third link is coupled to the radially extending arm by a bell crank and auxiliary link. The auxiliary link is operatively coupled to the radially extending arm by a third auxiliary ball joint. A stabilizing link is operatively coupled to the operator plate and a fixed element to preventing the rotation of the operator plate when the control lever is twisted. The centerpoints of the first, second and third auxiliary ball joints and the main ball joint are located in substantially the same plane.

### SUMMARY

In one aspect, the present disclosure provides an articulation joint linkage. The articulation joint linkage includes a first socket having a ball seat at a distal end. The articulation joint linkage includes a ball stud having a ball and a shank extending from the ball, the ball is arranged in the ball seat such that the ball stud is configured to articulate with respect to the first socket. The articulation joint linkage includes a locking ferrule. The locking ferrule includes a cavity receiving the ball therein, wherein the locking ferrule is attached to the first socket to hold the ball within the ball seat. The locking ferrule includes an opening, wherein the shank extends through the opening. The articulation joint linkage further includes a second socket having a bore receiving the shank of the ball stud therein.

In another aspect, the present disclosure provides an implement actuation assembly for a spool valve in a machine. The implement actuation assembly includes at least one lever. The implement actuation assembly includes a spool valve. The spool valve includes a spool extending from the spool valve and wherein the spool includes a through-hole. The implement actuation assembly further includes a linkage assembly. The linkage assembly includes at least one linkage arm coupled to the lever and the spool of the spool valve. The linkage assembly includes an articulation joint linkage connecting the linkage arm and the spool. The articulation joint linkage includes a first socket having a ball seat at a distal end. The articulation joint linkage includes a ball stud having a ball and a shank extending from the ball, the ball is arranged in the ball seat such that the ball stud is configured to articulate with respect to the first socket. The articulation joint linkage includes a locking ferrule. The locking ferrule includes a cavity receiving the ball therein, wherein the locking ferrule is attached to the first socket to hold the ball within the ball seat. The locking ferrule includes an opening, wherein the shank extends through the opening. The articulation joint linkage further includes a second socket having a bore receiving the shank of the ball stud therein and a spool opening receiving the spool of the spool valve.

Other features and aspects of this disclosure will be apparent from the following description and the accompanying drawings.

### BRIEF DESCRIPTION OF THE DRAWINGS

FIG. 1 illustrates an exemplary machine;

FIG. 2 illustrates a detailed view of an implement actuation assembly for the machine;

FIG. 3 illustrates an exploded view of an articulation joint linkage for the implement actuation assembly of FIG. 2;

FIG. 4 illustrates a cross-sectional view of the articulation joint linkage for the implement actuation assembly of FIG. 2; and

FIG. 5 illustrates a detailed view of the articulation joint linkage coupled to a first linkage arm and a spool valve of the implement actuation assembly.

### DETAILED DESCRIPTION

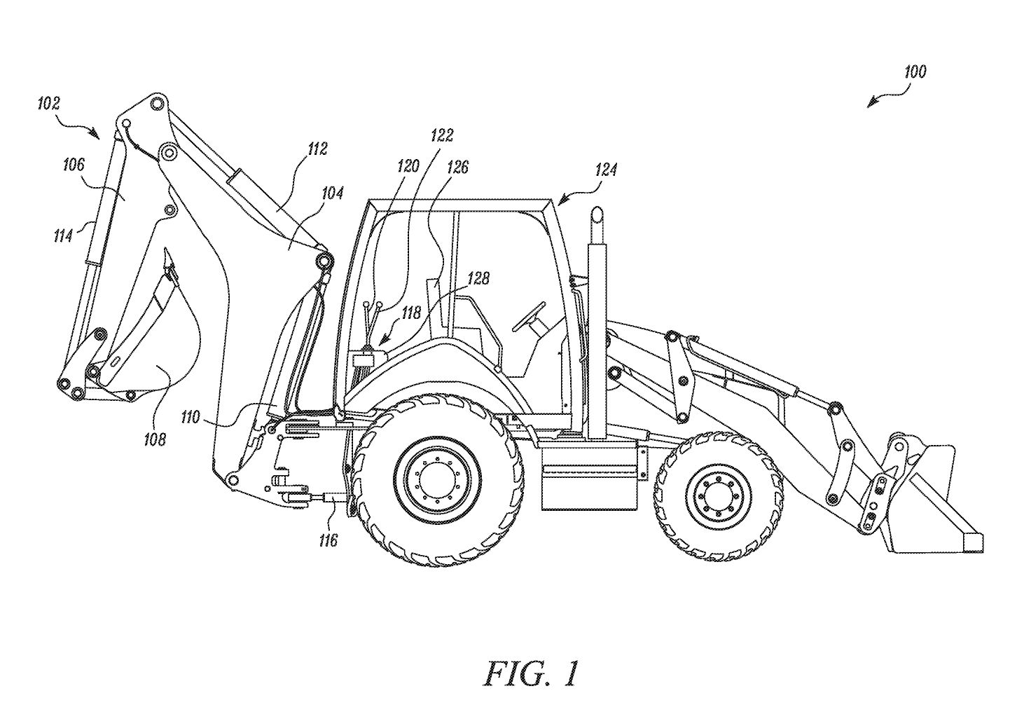

The present disclosure relates to an articulation joint linkage for a linkage assembly for a machine. FIG. 1 illustrates an exemplary machine 100. In the illustrated embodiment, the machine 100 is embodied as a backhoe loader, however in alternative embodiments the machine 100 may he any other machine such as a hydraulic excavator, a front shovel, a wheel loader, a track loader, or a skidder. The machine 100 may include an implement assembly 102. The implement assembly 102 includes a boom 104 pivotally connected to the machine 100, a stick 106 pivotally connected to the boom 104, and an implement 108 such as a bucket pivotally connected to the stick 106 The boom 104 may be actuated by a first hydraulic cylinder 110 to enable a raising and a lowering of the boom 104. The stick 106 may be drawn towards and away from the machine 100 by a second hydraulic cylinder 112. A third hydraulic cylinder 114 may be configured to curl and uncurl the implement 108. The machine 100 may further include a pair of fourth hydraulic cylinders 116 (only one shown) disposed on each side of the boom 104 and coupled to the machine 100. The pair of fourth hydraulic cylinders 116 is configured to enable a swing of the implement assembly 102 with respect to the machine 100.

In an embodiment the machine 100 may include an implement actuation assembly 118. The implement actuation assembly 118 may include a first lever 120, and a second lever 122 disposed in an operator cabin 124 associated with the machine 100. In an embodiment, the first lever 120, and the second lever 122 may be disposed on each side of an operator seat 126. However, in other embodiments, the levers 120, and 122 may be disposed on a dashboard 128 disposed in the operator cabin 124. In the preceding embodiments, it is disclosed that the levers 120, and 122 may be located on each side of the operator seat 126, or in other embodiments on the dashboard 128. However, a person having ordinary skill in the art may acknowledge that the locations of the levers 120. and 122 may be anywhere in the operator cabin 124 such that the implement assembly 102 may be appropriately connected to the levers 120, and 122.

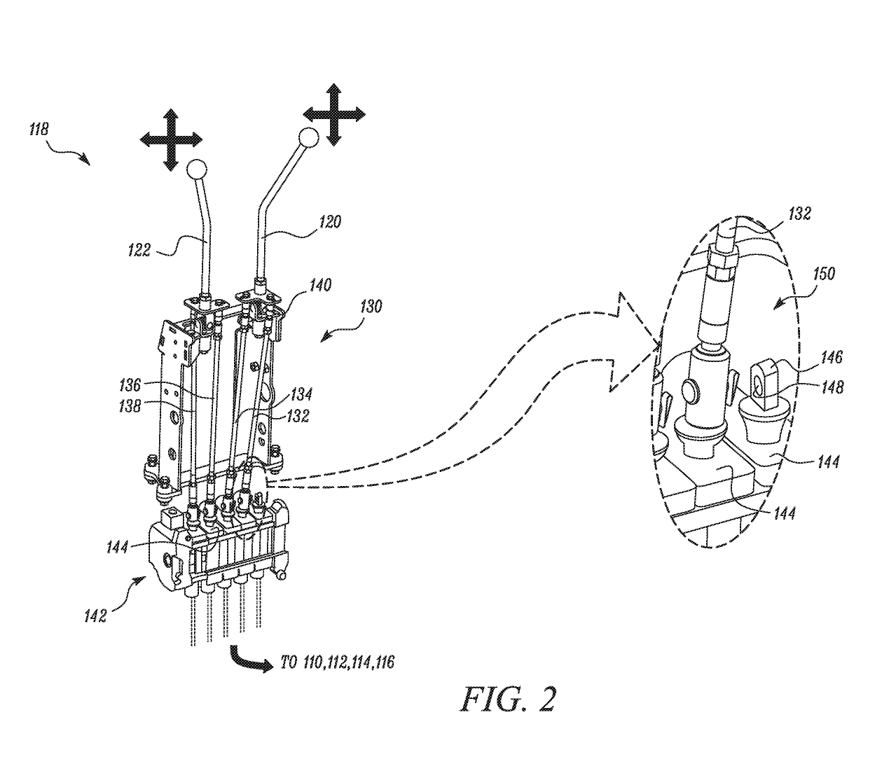

FIG. 2 illustrates a detailed view of the implement actuation assembly 118 of the present disclosure. The implement actuation assembly 118 includes a linkage assembly 130 coupled to the first lever 120 and the second lever 122. The linkage assembly 130 includes a first linkage arm 132 and a second linkage arm 134 operatively coupled to the first lever 120, and a third linkage arm 136 and a fourth linkage arm 138 operatively coupled the second lever 122. In an embodiment, the levers 120, and 122 may be coupled to the linkage arms 132, 134, 136, and 138 through bearing joints 140, such as roller bearings, as commonly known in the art.

In an embodiment, the levers 120, and 122 are movable in two directions, a fore-and-aft and a side-to-side. In an exemplary embodiment, the fore-and-aft movement of the first lever 120 may raise and lower the boom 104, and the side-to-side movement of the first lever 120 may swing the implement assembly 102. The stick 106 may be drawn towards and away from the machine 100 through the fore-and-aft movement of the second lever 122, and the side-to-side movement of the second lever 122 may curl and uncurl the implement 108. It will be apparent to a person ordinarily skilled in the art that a control of the implement assembly 102 through movements of the first lever 120 and the second lever 122 disclosed herein are merely exemplary and non-limiting of this disclosure. Hence, in alternative embodiments the first lever 120 may operatively control the implement 108 and the stick 106 and the second lever 122 may operatively control the boom 104.

In an embodiment as illustrated in FIG. 2, the fore-and-aft movement of the first lever 120 may correspondingly actuate a movement in the first linkage arm 132 and a side-to-side movement of the first lever 120 may correspondingly actuate a movement in the second linkage arm 134. Further, a fore-and-aft movement of the second lever 122 may correspondingly actuate a movement in the third linkage arm 136 and a side-to-side movement of the second lever 122 may correspondingly actuate a movement in the fourth linkage arm 138.

In an aspect of the present disclosure, the implement actuation assembly 118 includes a hydraulic spool valve assembly 142 operatively coupled to the linkage assembly 130. The hydraulic spool valve assembly 142 includes a plurality of spool valves 144 corresponding to the linkage arms 132, 134, 136, and 138 in the linkage assembly 130. Each of the spool valves 144 is hydraulically coupled to the corresponding hydraulic cylinders 110, 112, 114, and 116 associated with the implement assembly 102. Further, each of the spool valves 144 includes a spool 146 therein. The spool 146 includes a through-hole 148. In an embodiment, the spool valves 144 are spring loaded two position spool valves. However in alternative embodiments, the spool valves 144 may be other kind of a spool valves as commonly known in the art such that a movement of the spools 146 may allow an ingress and an egress of a fluid from and to the spool valves 144 to selectively pressurize the corresponding hydraulic cylinders 110, 112, 114, and 116 associated with the implement assembly 102.

In an aspect of the present disclosure, the linkage assembly 130 includes an articulation joint linkage 150. Each of the spool 146 associated with the spool valves 144 is operatively coupled to each of the linkage arms 132, 134, 136, and 138 via the respective articulation joint linkage 150. For the purpose of understanding the various embodiments of the present disclosure, reference hereinafter will be made to only one of the spool valves 144 including the spool 146 and coupled to the first linkage arm 132 via the articulation joint linkage 150 such that a movement in the first linkage arm 132 actuates the first hydraulic cylinder 110 associated with the implement assembly 102. Further, it will be acknowledged by a person skilled in the art that coupling of the remaining linkage arms 134, 136, and 138 to their respective spool valves 144 are substantially similar to the coupling of the first linkage arm 132 to the spool 146 of the spool valve 144 associated with the hydraulic spool valve assembly 142.

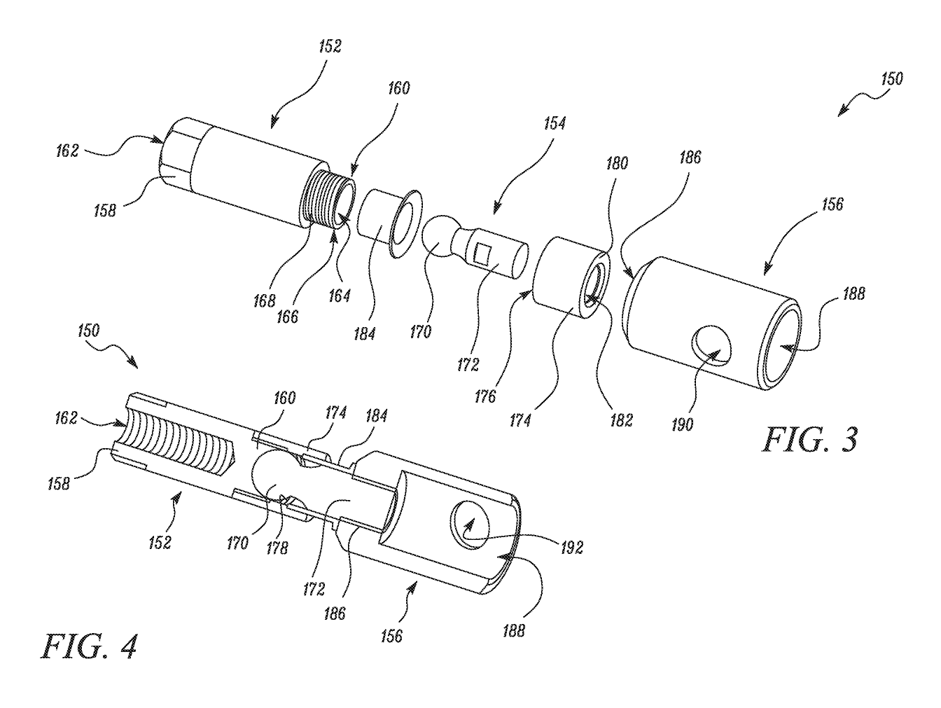

FIG. 3 and FIG. 4 illustrate an exploded view and a cross-sectional view of the articulation joint linkage 150 respectively. The articulation joint linkage 150 includes a first socket 152, a ball stud 154 and a second socket 156. The first socket 152 includes a proximal end 158 and a distal end 160. The proximal end 158 includes a threaded opening 162. The first socket 152 defines a ball seat 164 at the distal end 160. As illustrated in FIGS. 3 and 4, an outer surface 166 of the ball seat 164 at the distal end 160 includes external threads 168. The ball stud 154 has a ball 170 and a shank 172 extending from the ball 170. The ball 170 is arranged in the ball seat 164 of the first socket 152 such that the ball stud 154 may articulate with respect to the first socket 152.

According to an aspect of the present disclosure, the articulation joint linkage 150 includes a locking ferrule 174. The locking ferrule 174 defines a cavity 176 such that the ball 170 may be received therein. The locking ferrule 174 may include internal threads 178 that may be threadably fastened to the external threads 168 on the distal end 160 such that the locking ferrule 174 may be attached to the first socket 152 to hold the ball 170 within the ball seat 164. As illustrated in FIG. 3, the locking ferrule 174 includes a flange 180. The flange 180 extends inwardly towards the cavity 176 to define an opening 182. As illustrated in FIG. 4, the shank 172 of the ball stud 154 extends through the opening 182. The articulation joint linkage 150 further includes a seal 184 disposed around the ball stud 154. The seal 184 is partially received within the cavity 176 of the locking ferrule 174. The seal 184 extends over the ball stud 154 and rests on the second socket 156.

As illustrated in FIGS. 3 and 4, the second socket 156 defines a bore 186 and a spool opening 188. The shank 172 of the ball stud 154 is received within the bore 186. In an embodiment, the shank 172 may be threadably fastened within the bore 186, however in alternative embodiments the shank 172 may he chamfered and received within the bore 186 such that corresponding protrusions in the bore 186 may couple the shank 172 therein. The spool opening 188 receives the spool 146 of the spool valve 144. As illustrated in FIGS. 3 and 4, the second socket 156 includes a first hole 190 and a second hole 192 such that the first hole 190 and the second hole 192 correspond to the through-hole 148 of the spool 146.

In the preceding embodiments, the first socket 152 and the second socket 156 is designed such that they may receive the ball 170 and the shank 172 respectively. However, in an alternative embodiment, the first socket 152 may be designed to receive the shank 172 and the second socket 156 may be designed to receive the ball 170 therein. Hence it will be appreciated by one skilled in the art that various other embodiments may be contemplated to engage the spool 146 of the spool valve 144 to the first linkage arm 132 via the articulation joint linkage 150 such that the ball stud 154 may articulate with respect to the first linkage arm 132.

In the foregoing disclosure, the articulation joint linkage 150 is explained in conjunction to a machine configured to perform digging or loading functions, such as a backhoe loader. However, it may be noted that the application of the articulation joint linkage 150 for the backhoe loader disclosed herein is merely exemplary in nature and non-limiting of this disclosure. One may contemplate various other application areas for the articulation joint linkage 150 that includes manipulation of spool valves via linkage arms. A few examples may be, in marine applications, tooling industries, robotics and the like.

### INDUSTRIAL APPLICABILITY

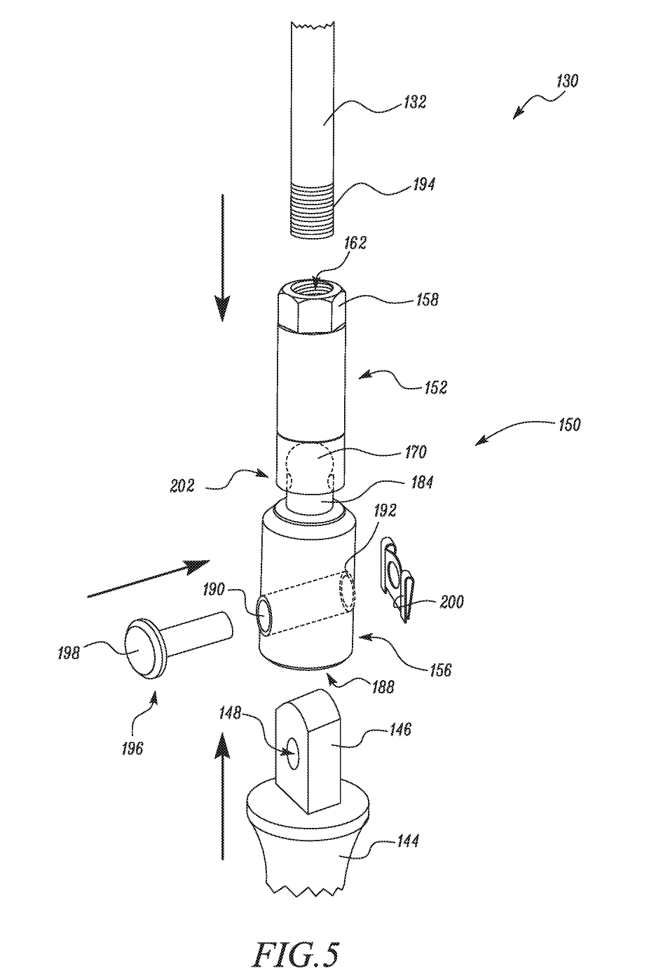

The industrial applicability of the articulation joint linkage for the implement actuation assembly for the machine described herein will be readily appreciated from the foregoing discussion. FIG. 5 illustrates a detailed view of the articulation joint linkage 150 coupled to the first linkage arm 132 and the spool valve 144 of the present disclosure. A threaded end 194 of the first linkage arm 132 is threadably fastened to the threaded opening 162 disposed at the proximal end 158 of the first socket 152. in an embodiment as illustrated in FIG. 5, the second socket 156 is configured to receive a locking member 196 extending through the through-hole 148 of the spool 146 between the first hole 190 and the second hole 192 of the spool opening 188 to couple the spool 146 to the second socket 156 of the articulation joint linkage 150. The locking member 196 may include a pin 198 and a retainer 200. The retainer 200 is configured to lock the pin 198. However, in alternative embodiments, the spool 146 may be coupled to the second socket 156 via a cotter pin joint as commonly known in the art.

The fore-and-aft movement in the first lever 120 may actuate a movement in the first linkage arm 132 such that the spool 146 associated with the spool valve 144 may actuate the first hydraulic cylinder 110. Conventionally a hydraulic valve assembly is coupled to a linkage assembly via a linkage joint. The linkage joint offers a clearance between the linkage assembly and the hydraulic valve assembly. This clearance creates a free-play between the linkage assembly and the hydraulic valve assembly and may lead to a slack in the motion of one or more hand operated levers.

With, the articulation joint linkage 150 of the present disclosure, the ball stud 154 and the ball seat 164, establish a ball joint 202 between the first socket 152 and the second socket 156. It will be apparent to a person skilled in the art that ball joints offer low friction and an improved angle of articulation between connecting parts. Hence, the linkage arms 132, 134, 136, and 138 are directly coupled to the respective spools 146 and, in operation the articulation joint linkage 150 allows precise maneuver of the implement assembly 102 by reducing the free-play and slack between the linkage arms 132, 134, 136, and 138 and the respective spools 146.

The seal 184 associated with the articulation joint linkage 150 deters an ingress of dust and drosses in the ball seat 164, and the cavity 176 of the first socket 152 and the locking ferrule 174 respectively. Hence, the seal 184 maintains a clearance between the ball seat 164 and the ball stud 154 such that the ball stud 154 may articulate with respect to the first socket 152.

Further, the articulation joint linkage 150 comprises assembly of a few parts that are easy to manufacture and convenient to assemble. With the appended disclosure, it will be apparent to a person skilled in the art that the articulation joint linkage 150 may be manufactured using a combination of tooling operations like reaming, boring, machining, milling and the like, which may be conveniently performed on a numerically controlled lathe machine. In an aspect of the present disclosure, the articulation joint linkage 150 may be manufactured using a heat treated alloy steel. The articulation joint linkage 150 may be electroplated to resist corrosion. The seal 184 may be manufactured using a nitrile rubber material. However, in other embodiments, the seal 184 and the articulation joint linkage 150 may be manufactured using materials such that the seal 184 and the articulation joint linkage 150 are imparted with properties of resistance to wear and dimensional deterioration over time and use.

From the foregoing it will be appreciated that, although specific embodiments have been described herein for purposes of illustration, various modifications or variations may be made without deviating from the spirit or scope of inventive features claimed herein. Other embodiments will be apparent to those skilled in the art from consideration of the specification and figures and practice of the arrangements disclosed herein. It is intended that the specification and disclosed examples be considered as exemplary only, with a true inventive scope and spirit being indicated by the following claims and their equivalents.

1. An articulation joint linkage comprising:
a first socket having a ball seat at a distal end;
a ball stud having a ball and a shank extending from the ball, the ball arranged in the ball seat such that the ball stud is configured to articulate with respect to the first socket;
a locking ferrule including:
a cavity receiving the ball therein, wherein the locking ferrule is attached to the first socket to hold the ball within the ball seat; and
an opening, wherein the shank extends through the opening; and
a second socket having a bore receiving the shank of the ball stud therein.

2. The articulation joint linkage of claim 1, wherein the locking ferrule includes a flange extending inwardly towards the cavity, the flange defining the opening.

3. The articulation joint linkage of claim 1 further including a seal disposed around the ball stud, wherein the seal is partially received in the cavity of the locking ferrule.

4. The articulation joint linkage of claim 1, wherein an outer surface of the ball seat is threaded and an inner surface of the locking ferrule is threaded.

5. The articulation joint linkage of claim 1, wherein the first socket has a threaded opening at a proximal end.

6. The articulation joint linkage of claim 5, wherein the first socket is configured to receive a linkage arm within the threaded opening.

7. The articulation joint linkage of claim 1, wherein the second socket defines a spool opening.

8. The articulation joint linkage of claim 7, wherein the spool opening is configured to receive a spool of a spool valve.

9. The articulation joint linkage of claim 7, wherein the second socket further includes a first hole and a second hole.

10. The articulation joint linkage of claim 9, wherein the second socket is further configured to receive a locking member extending through the spool opening and between the first hole and the second hole.

11. An implement actuation assembly for a spool valve in a machine, the implement actuation assembly comprising:
at least one lever;
a spool valve including a spool extending from the spool valve and wherein the spool includes a through-hole; and
a linkage assembly including:
at least one linkage arm coupled to the lever and the spool of the spool valve; and
an articulation joint linkage connecting the linkage arm and the spool, the articulation joint linkage including:
a first socket connected to the linkage arm at a proximal end and having a ball seat at a distal end;
a ball stud having a ball and a shank extending from the ball, the ball arranged in the ball seat such that the ball stud is configured to articulate with respect to the first socket;
a locking ferrule including:
a cavity receiving the ball therein, wherein the locking ferrule is attached to the first socket to hold the ball within the ball seat; and
an opening, wherein the shank extends through the opening; and
a second socket having a bore to receive the shank of the ball stud therein and a spool opening receiving the spool of the spool valve.

12. The implement actuation assembly of claim 11, wherein the locking ferrule includes a flange extending inwardly towards the cavity, the flange defining the opening.

13. The implement actuation assembly of claim 11, further including a seal disposed around the ball stud, wherein the seal is partially received in the cavity of the locking ferrule.

14. The implement actuation assembly of claim 11, wherein an outer surface of the ball seat is threaded and an inner surface of the locking ferrule is threaded.

15. The implement actuation assembly of claim 11, wherein the first socket has a threaded opening at the proximal end.

16. The implement actuation assembly of claim 11, wherein the second socket further includes a first hole and a second hole.

17. The implement actuation assembly of claim 16, wherein the second socket receives a locking member extending through a through-hole of the spool between the first hole and the second hole of the spool opening.

18. The implement actuation assembly of claim 15, wherein the first socket is configured to receive a linkage arm within the threaded opening.

19. The implement actuation assembly of claim 11, wherein the second socket defines a spool opening.

20. The implement actuation assembly of claim 19, wherein the spool opening is configured to receive a spool of a spool valve.
